(19) United States
(12) Patent Application Publication
(10) Pub. No.: US 2003/0118321 A1
(43) Pub. Date: Jun. 26, 2003

(54) Digital video recording and reproduction system and method suitable for live-pause playback utilizing intelligent buffer memory allocation

(76) Inventors: Carlton J. Sparrell, Marblehead, MA (US); Gordon Landis, Stow, MA (US); David F. Lively, Hudson, MA (US); Alexander Vasilevsky, Westford, MA (US)

Correspondence Address: LUCASH, GESMER & UPDEGROVE, LLP, 40 BROAD ST, SUITE 300, BOSTON, MA, 02109, US

(21) Appl. No.: 10/032,218

(22) Filed: Dec. 21, 2001

(51) Int. Cl. H04N 5/91; H04N 7/00

(52) U.S. Cl. 386/68

(57) ABSTRACT

A Digital Video Recording (DVR) system and method obviates the need for prior art circular video buffers and their associated problems by using information from a Program Guide Service to specify an appropriate length buffer. As a result, older portions of a program are not erased because of buffer size limitation, and system resources are not inefficiently allocated for small programs. The invention is especially compatible with live-pause recording and playback. At the viewer/user's option any program being played back or recorded can be stored in long-term memory.

### CROSS-REFERENCE TO RELATED APPLICATIONS

The present application for Letters Patent is based on and claims priority from Provisional Application Ser. No. XX/YYY,YYY filed Nov. 7, 2001, entitled “Digital Video Recording System Supporting Concurrent Playback Using Advanced Program Information” bearing attorney docket reference “UCNTC/EPGDVR2,” hereby incorporated by reference.

The present application also incorporates by reference, the following other applications:

U.S. patent application Ser. No. AA/BBB,BBB filed Dec. 14, 2001, entitled “Centralized Digital Video Recording And Playback System Accessible To Multiple Reproduction And Control Units Via A Home Area Network” bearing attorney docket number UCN-009;

U.S. Provisional Application Serial No. 60/327,627 filed Oct. 5, 2001, entitled “Home Area Network Centralized Digital Video Recorder;”

U.S. Provisional Application Serial No. 60/313,209 filed Aug. 17, 2001, entitled “Delivering Multimedia Over Home Area Networks;”

U.S. Provisional Application Serial No. 60/313,228 filed Aug. 17, 2001, entitled “Web Services Provisioning Architecture;”

U.S. Provisional Application Serial No. 60/193,813 filed Mar. 31, 2000, entitled “Home Area Network; and”

U.S. patent application Ser. No. 09/365,726 filed Aug. 3, 1999, entitled “Multi-Service In-Home Network With an Open Interface.”

### BACKGROUND OF THE INVENTION

1. Field of the Invention

The present invention generally relates to digital recording and playback systems and methods. More particularly, the present invention relates to improvements in system resource availability and efficacy for digital recording and playback systems and methods compatible with “live-pause,” or “elastic” recording/playback.

2. Background

Digital Video Recording and Playback systems are becoming more commonplace with the advances in technology and the downward trend in prices. Along with a playback quality that is superior to analog-based systems, Digital Video Recorders (DVRs) also allow other features that are not practical with analog-based systems. Among such features is the ability of a DVR user to engage in “live-pause” recording and playback.

Also known as “elastic” recording and playback, live-pause recording and playback allows a viewer/user with such an enabled system to watch a program live in real time while the program is being recorded, while also allowing the user to use “trick play” modes or functions such as pausing the program or rewinding the program. While the recorded program is being paused or rewound, the system continues to record the program in a buffer memory. The system keeps track of where in memory the user has exited to perform trick play functions. The user can later return to the previous point of viewing in the program or skip with a “fast forward” operation up to the most current point of recording. Live-pause recording and playback allows the user the flexibility of watching a program live, already recorded, or a combination of both live and recorded viewing, along with interesting trick play modes.

Prior art DVRs utilize a fixed-length circular buffer memory to store programs designated (by choice or by system default) for live-pause recording and playback. With a circular buffer, frame information (such as frames of a television broadcast) is written consecutively into the buffer memory until the end of the buffer memory is reached. Writing continues by wrapping around to the beginning of the buffer memory and overwriting as many consecutive memory locations as is needed. That is, when the buffer is filled, the system begins recording over the oldest information in the buffer.

This prior art approach is problematic on several fronts. Chiefly, when a small circular buffer is chosen, this approach often leads to indiscriminately and permanently erasing older program information that may be of long-term interest to a user. Alternatively, if a large circular buffer is used, the system sometimes devotes much more memory space to smaller programs than is actually needed, causing an inefficient use of limited system resources that could be freed up for other tasks.

The Applicants of this Letters Patent note the following U.S. Patent numbers as being generally related to live-pause Digital Video Recording, but having the same problems identified above with respect to circular buffers: RE 36,801; 5,241,428 and 5,329,320. The following U.S. Patents are noted as being generally relevant to live-pause recording and playback: 6,233,389 and 5,241,428.

What is desired, but absent in the prior art, and therefore of focus in this Letters Patent, is a Digital Video Recording system and method capable of live-pause recording and playback without the drawbacks of circular buffers.

### SUMMARY OF THE INVENTION

In view of the aforementioned problems and deficiencies of the prior art, the present invention provides a digital video recording and playback method adapted for “live-pause” recording and playback. The method at least includes the steps of providing at least one electronic audio-visual program source, via a program guide source, at least providing program length information about a program of interest, and converting the program length information into a corresponding buffer memory size. The method also at least includes the steps of establishing a buffer memory matching the buffer memory size determined, and recording a selected program in the buffer memory established. The buffer memory size matches the size needed to record the program of interest.

The present invention also provides a digital video recording and playback system adapted for “live-pause” recording and playback. The system at least includes an electronic audio-visual program source, a program guide source adapted to at least provide program length information about a program of interest, and a converter adapted to convert the program length information into a corresponding buffer memory size. The system further at least includes at least one buffer memory established and sized to match that determined by the converter, the buffer memory being adapted to record a selected program. The buffer memory size matches the size needed to record a program of interest.

### BRIEF DESCRIPTION OF THE DRAWING FIGURES

Features and advantages of the present invention will become apparent to those skilled in the art from the description below, with reference to the following drawing figures, in which:

FIG. 1 is a schematic block diagram of the present-inventive digital video recording and playback system; and

FIG. 2 is a flowchart detailing the present-inventive method for digital video recording and playback.

### DESCRIPTION OF THE PREFERRED EMBODIMENTS

The present-inventive digital video recording and playback system and method obviates the need for circular buffers by the “intelligent” establishment of buffers having sizes matching the requirements of programs of interest, so that it is not necessary to record over portions of the same buffer for a single program. It is also not necessary to devote a buffer having considerably more size than is needed for programs of interest. To establish a buffer of the appropriate size, the system novelly utilizes information from a program guide service about the start and end times of a currently viewed program to determine the size of the buffer needed (via a record/playback service in the preferred embodiment). A video manager establishes a buffer in the memory area of the system matching the size requirements.

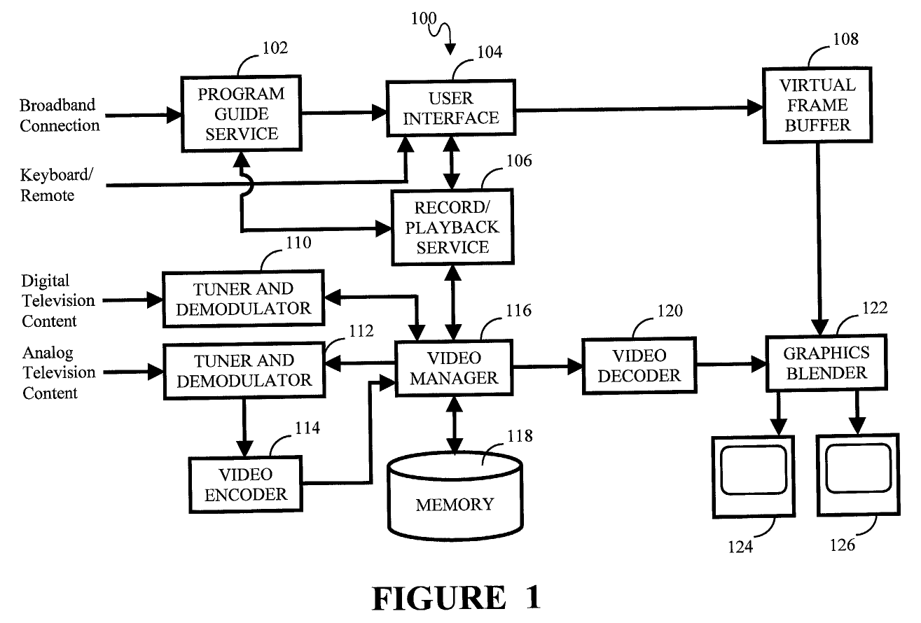

A general schematic diagram of the present-inventive digital video recording and reproduction system 100 is shown in FIG. 1. A program guide service 102 obtains information used by the system to construct an electronic program guide (EPG) to present details about programs to the system and to viewers in the form of a graphical user interface. In the preferred embodiment, the program guide service 102 obtains programming information via a broadband or wide area network (WAN) connection to a host computer. Those skilled in the art will appreciate that the programming information can be obtained through other types of connections, such as, inter alia, a cable MODEM, xDSL, POTS MODEM, satellite, and fixed terrestrial wireless.

For programs to be viewed and reproduced by the system 100, the program guide service provides information such as the program name, start and end times, channel designation, and additional information about the program such as the program rating, and a program synopsis. In an alternative system, the program guide information can be delivered in a different manner, such as in the video program stream as is known in the art. That is, along with the other audio and video information representing a television channel, for example, headers and other program description information can be included (e.g., program description information can be inserted in the vertical blanking interval of an NTSC television signal).

Information from the program guide service 102 is provided to a user interface 104 and a record/playback service 106. Accessible via a keyboard, an infrared remote control device, a pointing device such as a “mouse,” or other input means, the user interface is responsible for allowing the user to direct the operation of the system, as well as allowing the user to view information regarding the system operation. The user interface is also responsible for generating a graphical user interface containing an electronic program guide to be generated for display, based upon the program guide information, and input from the record/playback service (e.g., icons representing recording and playback statuses).

The record/playback service 106 controls the recording and playback of programs. Under the direction of the user interface 104 and utilizing program guide information, the record/playback service 106 establishes buffers of the appropriate size for recording programs. For example, if during a live-pause situation, a viewer begins watching an hour-long program at the scheduled start of the program, a buffer memory capable of storing a one-hour program is designated. However, if the user begins viewing an hour-long program ten minutes after its start, the record/playback service 106 determines that the buffer will need enough capacity to record a fifty-minute television program. The record/playback service 106 is also responsible for releasing a buffer memory area for overwriting when the buffer is no longer needed. This occurs either at the direction of the user, when the user changes the channel during live-pause recording and playback, or when a buffer stores the oldest program and new buffer memory space is needed to store new programs. Finally, the record/playback service handles traditional timer recording common to most video recording systems.

The program signals are delivered to a video manager 116 via tuning and demodulation circuits 110 and 112. The tuning and demodulation circuit 110 tunes the system to the program channel of interest (under the direction of the user interface 104 via the video manager 116), and then demodulates the signal in a manner known in the art. The program signal in this example is a digital television signal. The system 100 is also capable of receiving analog program signals (such as in the NTSC format), and tuning and demodulating them with the tuning and demodulating circuit 112.

The analog content signal need not initially be in a modulated form, as in the example, but may be unmodulated, in which case the tuning and demodulation circuit 112 is bypassed. Such an unmodulated analog content signal may be coupled to the system 100 via an “S-video” jack. Similarly, the digital content signal can be received either in a modulated form, or an unmodulated form (such as a straight ATSC stream), which for the latter case, the tuning and demodulation circuit 110 is bypassed. It should be appreciated by those skilled in the art that more than one tuning and demodulating circuit for a given type of signal (e.g., digital or analog) can be incorporated without departing from the spirit of the present invention.

As the video manager 116 in the preferred embodiment is configured to receive a compressed, digitally formatted signal, the output of the circuit 112 is also passed through a video encoder 114. Those skilled in the art will appreciate that the program signals handled by the video manager 116 can be encoded using one or more of the Motion Picture Experts Group (MPEG) digital video standards, as well as others.

In addition to controlling program channel tuning, the video manager 116 also controls the operation of the encoder 114, and controls the direct allocation and releasing of buffer memories in the system memory 118, as well as managing, under the direction of the record/playback service 106, the writing and retrieving (and the manner of writing and retrieving, such as the recording and playback speeds and trick play modes) of program information to the actual buffer memories and long-term memory.

A video decoder 120 performs the function of converting a digital program signal to a form suitable for display on the system displays 124 and 126. The displays 124 and 126 can be any suitable ones, including, inter alia, CRTs, projection screens, and solid state displays. Those skilled in the art will appreciate that the exact method of decoding will depend on the nature of the encoding previously used. In the preferred embodiment, the program signals to be displayed are passed through the video manager, whether they emanate directly from the tuning and demodulating circuits, or from memory.

The system memory 118 can be of any suitable high-capacity variety, whether or not moving components are integral to the operation thereof.

As an added security feature to prevent unauthorized system access or program copying, the programs can be encrypted at some point in the programming stream, whether before storage or after storage, with the encryption method being a matter of design choice.

A graphics blender 122 performs the function of blending disparate video input streams into one signal compatible with the displays 124 and 126. Typically, this involves combining an interactive graphical user interface having the program guide information with the program being viewed.

A virtual frame buffer 108 holds the graphical user interface information for refreshing the displays 124 and 126. In the preferred embodiment, video decoding and graphics blending are local to the television sets. Therefore, where, as here, the system 100 has multiple television sets (like the ones 124 and 126), multiple video decoders and graphics blenders exist in the system. For example, when all or most of the basic system hardware resides in one room of a dwelling such as the living room, a television in another room of the dwelling such as a bedroom will also need to carry out video decoding and graphics blending functions. The signal from the DVR to the television will be received over a home are network. The communication over the home area network includes, for example, communication between components 116 and 120, 108 and 122, and 120 and 122.

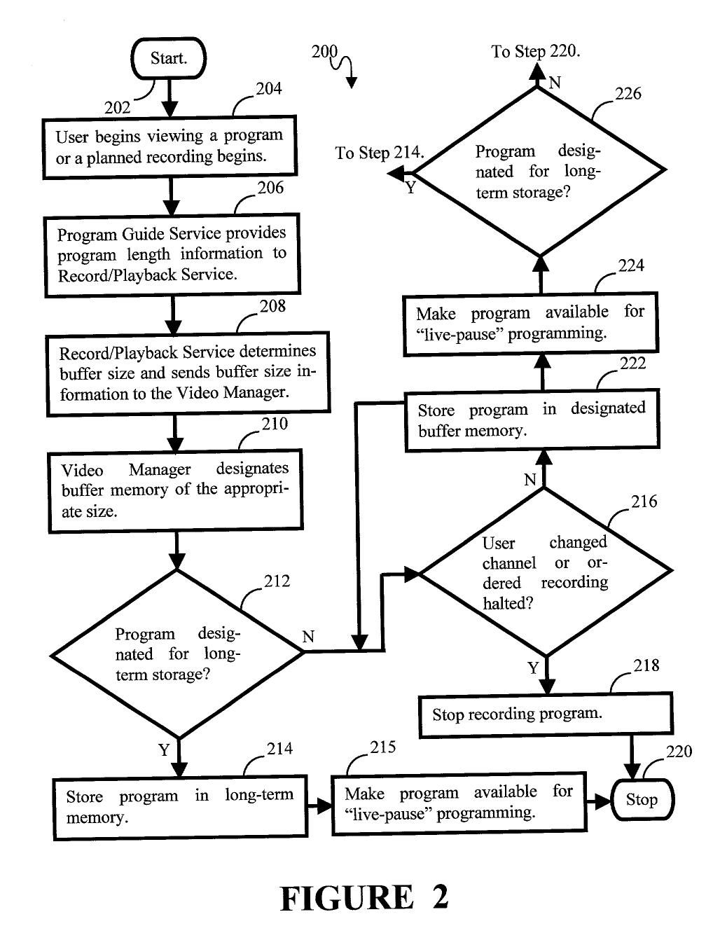

FIG. 2 illustrates an algorithm 200 for executing live-pause operations according to the present invention. The live-pause feature can be either selectively triggered by the user, or set to automatically trigger, as is the choice of the user. The algorithm 200 is started (Step 202) by the user either viewing a program or indicating that he or she wishes to record a program (Step 204).

Next, the program guide service provides program length information for the currently viewed program to the record/playback service (Step 206). The record/playback service determines the appropriate buffer memory size needed to fully record the program in Step 208. Recall that the program length information includes such things as the start and end times of the program where definitely known, or can either involve an estimate according to a rule set or standard block sizes. For example, if the program guide information indicates that the program currently viewed is a major television network movie that started 30 minutes late than originally scheduled, a buffer memory capable of storing two hours will be utilized rather than one for just one and one-half hours.

In Step 210 the video manager designates the actual buffer in the system memory. If the user has chosen the current program from long-term storage, it is so stored in Step 214. All programs are available for live-pause recording and playback at all stages of the present-inventive process. This reflected by Steps 215 and 224. The algorithm stops (Step 220) after recording is complete. Otherwise, the algorithm determines whether the user has changed the program channel or has halted recording the current program by some other action. If so, the recording is stopped (Step 218). If the user has not caused recording to be stopped, it is stored in the designated buffer memory (Step 222) and made available for live-pause viewing (Step 224).

The user can elect at any time to have a program stored in long-term storage. This is symbolically illustrated by Step 212 and also Step 226. To summarize, the system 100 allows a user to view any program in live-pause mode at any time, and allows any program to be stored in long-term memory prior to the buffer memory being discarded. The following are examples illustrating these basic features.

In a first example, the user viewing a program in live-pause mode decides that the program should be stored in long-term memory. The buffer memory used to initially store the program can then serve as the long-term memory. The buffer/long-term memory will continue to record the program until it is complete. After the program has been designated for long-term storage, the user can continue to view the current program or tune to a new program.

In a second example, a user has decided to record a program (e.g., a sporting event) into long-term storage prior to viewing it. While the program is being recorded into memory, it is also available for live-pause playback when the user tunes to the program.

In a third example, the user views an entire program in live-pause mode without designating it for long-term storage. Upon changing the channel and thus tuning to a new program, the buffer memory for the previously-recorded program is released for overwriting by future programs.

Variations and modifications of the present invention are possible, given the above description. However, all variations and modifications which are obvious to those skilled in the art to which the present invention pertains are considered to be within the scope of the protection granted by this Letters Patent.

What is claimed is:

1. A digital video recording and playback method adapted for “live-pause” recording and playback, said method comprising the steps of:
a) providing at least one electronic audio-visual program source;
b) via a program guide source, at least providing program length information about a program of interest;
c) converting said program length information into a corresponding buffer memory size;
d) establishing a buffer memory matching the buffer memory size determined in step c); and
e) recording a selected program in the buffer memory established in step d);
wherein said buffer memory size matches the size needed to record said program of interest.

2. The method in claim 1, wherein said program length information comprises the scheduled end time of a program of interest.

3. The method in claim 1, wherein said program length information comprises the scheduled start time of a program of interest.

4. The method in claim 1, further comprising the step of:
at the direction of a user, designating a program stored in said buffer memory for long-term storage.

5. The method in claim 1, wherein for programs of indefinite length, said program length information comprises as a default, a fixed length.

6. The method in claim 1, further comprising the step of:
releasing said established buffer memory from recording a current program, and making its memory space available to part of another buffer memory if needed, when the current program has been recorded.

7. The method in claim 1, further comprising the step of:
releasing said established buffer memory from recording a current program, and making its memory space available to part of another buffer memory if needed, when a user tunes in to another program.

8. The method in claim 1, further comprising the step of:
releasing said established buffer memory from recording a current program, and making its memory space available to part of another buffer memory if needed, when a user directs that recording be halted.

9. A digital video recording and playback system adapted for “live-pause” recording and playback, said system comprising:
a) at least one electronic audio-visual program source;
b) a program guide source adapted to at least provide program length information about a program of interest;
c) a converter adapted to convert said program length information into a corresponding buffer memory size; and
d) at least one buffer memory established and sized to match that determined by said converter, said buffer memory being adapted to record a selected program;
wherein said buffer memory size matches the size needed to record a program of interest.

10. The system in claim 9, wherein said program length information comprises the scheduled end time of a program of interest.

11. The system in claim 9, wherein said program length information comprises the scheduled start time of a program of interest.

12. The system in claim 9, wherein said established buffer memory is adapted to become, at the direction of a user, part of a long-term memory for the long-term storage of a program stored therein.

13. The system in claim 9, wherein for programs of indefinite length, said program length information comprises as a default, a fixed length.

14. The system in claim 9, wherein said established buffer memory is adapted to be released from recording a current program, and making its memory space available to part of another buffer memory if needed, when the current program has been recorded.

15. The system in claim 9, wherein said established buffer memory is adapted to be released from recording a current program, and making its memory space available to part of another buffer memory if needed, when a user tunes in to another program.

16. The system in claim 9, wherein said established buffer memory is adapted to be released from recording a current program, and making its memory space available to part of another buffer memory if needed, when a user directs that recording be halted.

17. A digital video recording and playback method adapted for “live-pause” recording and playback, said method comprising the steps of:
a) providing at least one electronic audio-visual program source;
b) adaptively establishing a buffer memory having a size adequate to record a program of interest; and
c) recording a selected program in the buffer memory established in step b).

18. The method in claim 17, wherein the size of said buffer memory is set to one of a plurality of fixed sizes to match an estimated size of a program of interest.

19. The method in claim 17, further comprising the step of:
at the direction of a user, designating a program stored in said buffer memory for long-term storage.

20. The method in claim 17, further comprising the step of:
releasing said established buffer memory from recording a current program, and making its memory space available to part of another buffer memory if needed, when the current program has been recorded.

21. The method in claim 17, further comprising the step of:
releasing said established buffer memory from recording a current program, and making its memory space available to part of another buffer memory if needed, when a user tunes in to another program.

22. The method in claim 17, further comprising the step of:
releasing said established buffer memory from recording a current program, and making its memory space available to part of another buffer memory if needed, when a user directs that recording be halted.

23. A digital video recording and playback system adapted for “live-pause” recording and playback, said system comprising:
a) at least one electronic audio-visual program source; and
b) at least one adaptively established buffer memory having a size adequate to record a program of interest;
wherein said buffer memory is adapted to record a selected program.

24. The system in claim 23, wherein the size of said buffer memory is set to one of a plurality of fixed sizes to match an estimated size of a program of interest.

25. The system in claim 23, wherein said established buffer memory is adapted to become, at the direction of a user, part of a long-term memory for the long-term storage of a program stored therein.

26. The system in claim 23, wherein said established buffer memory is adapted to be released from recording a current program, and making its memory space available to part of another buffer memory if needed, when the current program has been recorded.

27. The system in claim 23, wherein said established buffer memory is adapted to be released from recording a current program, and making its memory space available to part of another buffer memory if needed, when a user tunes in to another program.

28. The system in claim 23, wherein said established buffer memory is adapted to be released from recording a current program, and making its memory space available to part of another buffer memory if needed, when a user directs that recording be halted.
